(19) United States
(12) Patent Application Publication
(10) Pub. No.: US 2026/0126681 A1
(43) Pub. Date: May 7, 2026

(54) METHOD FOR CONTROLLING A PDLC FUNCTIONAL ELEMENT HAVING SEVERAL INDEPENDENTLY SWITCHABLE SWITCHING REGIONS

(71) Applicant: SAINT-GOBAIN SEKURIT FRANCE, Thourotte (FR)

(72) Inventors: Achim ZEICHNER, HERZOGENRATH (DE); Jefferson DO ROSARIO, HERZOGENRATH (DE); Huixing ZHANG, HERZOGENRATH (DE); Tobias Peter ASCHENBRENNER, HERZOGENRATH (DE)

(21) Appl. No.: 19/118,268

(22) PCT Filed: Sep. 20, 2023
(86) PCT No.: PCT/EP2023/075920

§ 371 Date: Apr. 3, 2025

(30) Foreign Application Priority Data
Oct. 7, 2022 (EP) 22200279.2

(51) Int. Cl. G02F 1/133; B60J 3/04; G02F 1/1334

(52) U.S. Cl. CPC G02F 1/13306; B60J 3/04; G02F 1/1334

(57) ABSTRACT

A method for controlling a PDLC functional element having at least two adjacent, independently switchable switching regions, wherein switching states (on, off) can be applied to the switching regions by a control unit, wherein A) different switching states (on, off) are applied to at least two adjacent switching regions; B) a signal is sent to the control unit by a user or an automatic control to change the switching states (on, off) in the individual switching regions; C) first all switching regions are set to the “on” switching state; and D) the changed switching states are then applied to the switching regions.

The invention relates to a method for controlling a PDLC functional element having several independently switchable switching regions, to a glazing unit and to the use thereof.

Glazing units with electrically controllable optical properties are known as such. They comprise laminated panes equipped with functional elements whose optical properties can be changed by an applied voltage. The voltage is applied via a control unit which is connected to two planar electrodes of the functional element, between which the active layer of the functional element is located. An example of such functional elements are SPD (suspended particle device) functional elements, which are known, for example, from EP 0876608 B1 and WO 2011033313A1. By applying voltage, the transmission of visible light can be controlled by SPD functional elements. Another example are standard PDLC (polymer-dispersed liquid crystal) functional elements, which are known, for example, from DE 102008026339 A1. The active layer contains liquid crystals which are embedded in a polymer matrix. If no voltage is applied in the “off” switching state, the liquid crystals will be aligned in an unordered manner, which results in strong scattering of the light passing through the active layer. In the “on” switching state, a voltage is applied to the planar electrodes so that liquid crystals will align in a common direction and the transmittance of light through the active layer is increased. The PDLC functional element thus operates primarily by increasing the scattering instead of by reducing the total transmission, as a result of which a clear view can be prevented or anti-glare protection can be ensured. Electrochromic functional elements are also known, for example from US 20120026573A1, WO 2010147494 A1 and EP 1862849 A1 and WO 2012007334A1, in which a change in transmission is the result of electrochemical processes which is induced by the applied electrical voltage.

Such glazing units can be used, for example, as vehicle window panes, the optical properties of which can then be controlled electrically. They can be used, for example, as roof panes to reduce exposure to direct sunlight or disruptive reflections. Such roof panes are known, for example, from DE 10043141 A1 and EP 3456913A1. Windshields have also been proposed in which an electrically controllable sun screen is realized by a switchable functional element in order to replace the conventional mechanically foldable sun screen in motor vehicles. Windshields with electrically controllable sun screens are known, for example, from DE 102013001334A1, DE 102005049081B3, DE 102005007427 A1 and DE 102007027296A1.

It is also known to provide such glazing units or the switchable functional elements in the glazing units with a plurality of switching regions, the optical properties of which can be switched independently of one another. For example, one region of the functional element can be selectively darkened or provided with a high level of light scattering, while other regions remain clear or transparent. Glazing units with independent switching regions and a method for their production are known, for example, from DE 202021105089U 1, WO 2014072137 A1 or WO 2017157626A1.

The independent switching regions are typically formed by one of the planar electrodes being subdivided by isolation lines into switching regions ((electrode) segments), which are separated from one another and are each connected independently of one another to the control unit and which can therefore be controlled independently, while the other planar electrode does not have any isolation lines, for example. The insulation lines are typically introduced into the planar electrode by laser machining. The planar electrodes cannot be selected with respect to optimal electrical conductivity, since they must be transparent to ensure transparency of the laminated pane. Typically used as planar electrodes are ITO layers which have low conductivity or high electrical resistance.

An electrical control unit for controlling functional elements with electrically controllable optical properties is known, for example, from EP 3910412A1.

The present invention is based on the object of providing an improved method for controlling a PDLC functional element with at least two adjacent, independently switchable switching regions.

The object is achieved according to the invention by a method for controlling a PDLC functional element with at least two adjacent, independently switchable switching regions, wherein switching states (on, off) can be applied to the switching regions by a control unit, wherein
A) different switching states (on, off) are applied to at least two adjacent switching regions;
B) a signal is sent to the control unit by a user or an automatic control to change the switching states (on, off) in the individual switching regions;
C) first all switching regions are set to the “on” switching state; and
D) the changed switching states are then applied to the switching regions.

It shall be understood that in step D) switching regions that are to be set to “on” can remain “on”.

The method according to the invention is characterized in that in an (intermediate) step C all switching regions are set to the uniform “on” switching state before a new switching state distribution is applied to the switching regions. This restores the original memory state of different switching states in the switching regions, and all switching regions again show the same optical properties.

In an advantageous embodiment of the method according to the invention, in step C the “on” switching state is applied in all switching regions simultaneously.

In an advantageous embodiment of the method according to the invention, in step C the “on” switching state is applied in the switching regions at different times. Preferably, the “on” switching state is applied in the switching regions in a rolling function, i.e., for example, by switching on (“on” switching state) from one side of the PDLC functional element in a consecutive sequence of the individual switching regions up to the opposite side and particularly preferably back again. It shall be understood that this process can be carried out several times in succession.

Alternatively, the switching regions can be switched in alternating sequence. For example, in case of a glazing with nine switching regions, the first, third, fifth, seventh and ninth switching regions can first be switched to “on” and then these regions can be switched to “off”, and the second, fourth, sixth and eighth switching regions alternately.

It shall be understood that further sequences can be switched, for example from opposite sides continuously towards the middle, i.e., in the above example with 9 switching regions, starting with switching regions one and nine, then two and eight, then three and seven, then four and six and finally the middle switching region five.

In an advantageous embodiment of the method according to the invention, step D is carried out only after each switching region has been set to the “on” switching state at least once.

In another advantageous embodiment of the method according to the invention, in step C the “on” switching state is held in the switching regions for a time period t of greater than or equal to 1/60 s, preferably greater than or equal to 0.5 s and in particular for 0.5 s to 10 s. This ensures an almost completely restored memory state and thus a sufficient homogenization of the optical properties of the switching regions.

The object is further achieved according to the invention by a glazing unit with a PDLC functional element, comprising
a laminated pane, comprising:
an outer pane and an inner pane, which are connected to one another via at least one thermoplastic intermediate layer;
a PDLC functional element with at least two adjacent, independently switchable switching regions, which is arranged between the outer pane and the inner pane, wherein
the PDLC functional element has at least two adjacent, independently switchable switching regions,
   and
a control unit for electrically controlling the optical properties of the switching regions of the PDLC functional element,
   wherein the control unit is provided to carry out the method according to the invention.

In an advantageous embodiment, the glazing unit according to the invention comprises a laminated pane, wherein the laminated pane comprises an outer pane and an inner pane, which are connected to one another via a thermoplastic intermediate layer, and an electrically controllable functional element arranged between the outer pane and the inner pane. The functional element has an active layer with electrically controllable optical properties between a first planar electrode and a second planar electrode. The control unit is configured such as to control the optical properties of the functional element.

In another advantageous embodiment, the PDLC functional element comprises an active layer having electrically controllable optical properties and is arranged between a first planar electrode and a second planar electrode. Advantageously, the first planar electrode is divided into at least two separate electrode segments by at least one isolation line, wherein each electrode segment forms an independently switchable switching region.

In another advantageous embodiment, each electrode segment of the first planar electrode and the second planar electrode are electrically connected to the control unit, so that an electrical voltage can be applied between each electrode segment of the first planar electrode and the second planar electrode, independently of one another, in order to control the optical properties of the section of the active layer located therebetween.

In another advantageous embodiment, the second planar electrode has no isolation lines or a smaller number of isolation lines and consequently a smaller number of electrode segments than the first planar electrode, so that at least one electrode segment of the second planar electrode is assigned several electrode segments of the first planar electrode.

The invention is based on the finding that the switching behavior and the optical properties, such as diffusivity and transmission of typical PDLC functional elements, depend on their wiring. The method according to the invention and the glazing unit according to the invention prevent the occurrence of deviating optical properties of the PDLC functional element in the switched off state (“off” switching state) caused by the so-called “memory effect” of PDLC functional elements. This memory effect is a visible effect that consists in that a switching region (electrode segment) that was recently switched on (“on” switching state) has a different opacity and/or a different scattering behavior in the subsequent switched off state (“off” switching state) than an adjacent PDLC switching region that was switched off for a very long time (“off” switching state) and/or has a different switching history.

This can be remedied by briefly switching on (“on” switching state) all switching regions, which leads to a restoration of the original memory state and to a homogenization of the optical properties.

For example: If, in a standard PDLC functional element, all odd switching regions of a glazing unit designed, for example, as a roof pane with nine switching regions were switched on for 5 minutes and the entire roof is then switched off (becomes opaque), the passenger in the car can clearly see a difference in the opacity between the odd and the even switching regions. To prevent this experience, which is unsatisfactory for the customer, various countermeasures can be introduced at the system level, such as introducing a homogenizing sequence (e.g., switching all switching regions in a rolling function) after certain switching operations; a start and end sequence or the simultaneous switching on and off of all switching regions. In other words, to achieve homogeneous optical properties, each switching region must be switched regularly to keep all switching regions in a similar state of opacity or transmission.

The glazing unit and the method are described together below, wherein explanations and preferred embodiments relate equally to glazing unit and method. If preferred features are described in connection with the method, this means that the glazing unit is preferably designed and is suitable accordingly. If, on the other hand, preferred features are described in connection with the glazing unit, this means that the method is also preferably carried out accordingly.

The laminated pane according to the invention, in particular as part of a glazing unit according to the invention, comprises at least one outer pane and one inner pane which are connected to one another via at least one thermoplastic intermediate layer. The laminated pane is provided for separating the interior space from the external environment in a window opening (in particular a window opening or roof opening of a vehicle, but alternatively also a window opening of a building or a room). In the context of the invention, the term “inner pane” is understood to mean the pane facing the interior space. Outer pane means the pane facing the external environment. The outer pane and the inner pane each have an outer and an interior-side surface and a circumferential side edge surface extending between them. In the sense of the invention, the outer-side surface means the main surface which is intended to face the external environment when installed. In the sense of the invention, the interior-side surface means the main surface which is intended to face the interior when installed. The interior-side surface of the outer pane and the outer-side surface of the inner pane face one another and are connected to one another by the thermoplastic intermediate layer.

The laminated pane according to the invention contains a PDLC functional element with electrically controllable optical properties which is arranged between the outer pane and the inner pane, i.e., is embedded in the intermediate layer. The functional element is preferably arranged between at least two layers of thermoplastic material of the intermediate layer, wherein it is connected to the outer pane by the first layer and to the inner pane by the second layer. Alternatively, however, the functional element can also be arranged directly on the surface of the outer pane or the inner pane facing the intermediate layer. Preferably, the lateral edge of the functional element is completely surrounded by the intermediate layer, so that the functional element does not extend all the way to the lateral edge of the laminated pane and therefore has no contact with the surrounding atmosphere.

The PDLC functional element comprises at least one active layer and two planar electrodes which are arranged on both sides of the active layer so that the active layer is arranged between the planar electrodes. The planar electrodes and the active layer are typically arranged essentially parallel to the surfaces of the outer pane and the inner pane. The active layer has the variable optical properties which can be controlled by a voltage applied to the active layer via the planar electrodes. In the context of the invention, electrically controllable optical properties are understood, in particular, to mean such properties which are continuously controllable. In the context of the invention, the switching state of the functional element means the extent to which the optical properties are changed compared to the voltage-free state. A 0% switching state corresponds to the voltage-free state while a 100% switching state corresponds to the maximum change in optical properties. Between the two aforementioned states, all switching states can be continuously realized by selecting the voltage accordingly. A switching state of 20% corresponds, for example, to a change in the optical properties by 20% of the maximum change. Said optical properties relate in particular to the light transmission and/or the scattering behavior.

In principle, however, it is also conceivable that the electrically controllable optical properties can only be switched between two discrete states. In that case, only two switching states exist, for example 0% (off) and for example 100% (on). It is also conceivable that the electrically controllable optical properties can be switched between more than two discrete states.

The planar electrodes are preferably transparent, which in the context of the invention means that they have a light transmission in the visible spectral range of at least 50%, preferably at least 70%, particularly preferably at least 80%. The planar electrodes preferably contain at least one metal, a metal alloy or a transparent conducting oxide (TCO). The planar electrodes can be formed, for example, on the basis of silver, gold, copper, nickel, chromium, tungsten, indium tin oxide (ITO), gallium-doped or aluminum-doped zinc oxide and/or fluorine-doped or antimony-doped tin oxide, preferably on the basis of silver or ITO. The surface electrodes preferably have a thickness of 10 nm to 2 μm, particularly preferably of 20 nm to 1 μm, very particularly preferably of 30 nm to 500 nm.

According to the invention, the first planar electrode has at least two segments (electrode segments) which are separated from one another by an insulation line. The insulation line is understood to mean a line-like region in which the material of the planar electrode is not present, so that the adjacent segments are materially separated from one another and are therefore electrically insulated from one another. This means that there is no direct electrical connection between the electrode segments, but the electrode segments can be connected to one another indirectly to a certain extent in an electrically conductive manner via the active layer in contact with them. The first planar electrode can be subdivided into several segments by several insulation lines. Each electrode segment forms a switching region of the glazing arrangement. The number of electrode segments can be freely selected by the person skilled in the art as needed on an individual basis. In a preferred embodiment, the isolation lines run substantially parallel to one another and extend from a side edge of the planar electrode to the opposite side edge. However, any other geometric shapes are also conceivable.

Two electrode segments separated only by an isolation line form an adjacent switching region within the meaning of the invention, which can also be referred to as an immediately adjacent switching region.

The isolation lines have, for example, a width of 5 μm to 500 μm, in particular 20 μm to 200 μm. They are preferably introduced into the planar electrode by means of laser radiation. The width of the segments, i.e., the distance between adjacent insulation lines, can be suitably selected by the person skilled in the art according to the requirements in individual cases.

The second planar electrode and the active layer preferably each form a coherent, complete layer, which are not subdivided into segments by insulation lines. In principle, however, it is also conceivable that the second planar electrode is segmented to a lesser extent than is the first planar electrode, i.e., has fewer insulation lines and electrode segments, so that a plurality of electrode segments of the first planar electrode are assigned to at least one electrode segment of the second planar electrode. The crosstalk problem arises in this case too, but it can be reduced by the approach according to the invention. Each isolation line of the second planar electrode is arranged in coincidence with an isolation line of the first planar electrode in the viewing direction through the laminated pane.

The electrode segments of the first planar electrode are electrically connected to the control unit independently of one another, so that a first electrical potential (which is variable over time in the case of an AC voltage) can be applied to each electrode segment (irrespective of the other electrode segments), which potential is referred to as switching potential in the context of the invention. The second planar electrode is also electrically connected to the control unit, so that, overall, a second electrical potential can be applied to the second planar electrode, which is referred to as reference potential (ground) in the context of the invention. If the first and the second potential are identical, no voltage will be present between the electrodes in the respective switching region (off switching state, 0%). If the first and the second potential are different, a voltage will be present between the electrodes in the respective switching region whereby a finite switching state is produced.

In one variant of the invention, the second planar electrode is also segmented, but to a lesser extent than the first planar electrode, so that several electrode segments of the first planar electrode are assigned to at least one electrode segment of the second planar electrode. In that case, the electrode segments of the second planar electrode are also electrically connected to the control unit independently of one another, so that a second electrical potential (reference potential, “ground”) can be applied to each electrode segment (independently of the other electrode segments). However, there is at least one electrode segment of the second planar electrode, which provides the reference potential for several switching regions. The affected switching regions can be controlled independently of one another in that the switching potential can be applied to the electrode segments of the first planar electrode independently of one another, while a single reference potential is applied to the associated electrode segment of the second planar electrode.

The control unit is provided and suitable for controlling the optical properties of the PDLC functional element. The control unit is electrically conductively connected, on the one hand, to the planar electrodes of the functional element and, on the other hand, to a voltage source. The control unit contains the electrical and/or electronic components required for applying the required voltage to the planar electrodes as a function of a switching state. The switching state can be predefined by the user (for example by operating a switch, a button or a rotary or sliding controller), can be determined by sensors and/or can be transmitted via a digital interface from the central control device of the vehicle (if the laminated pane is a vehicle window pane, usually LIN bus or CAN bus). The switches, buttons, rotary or sliding controllers can be integrated, for example, in the dashboard of the vehicle if the laminated pane is a vehicle window pane. However, touch sensors can also be integrated directly into the laminated pane, for example capacitive or resistive sensors. Alternatively, the functional element can also be controlled by contactless methods, for example by recognizing gestures, or as a function of the state of pupil or eyelid determined by a camera and suitable evaluation electronics. The control unit can comprise, for example, electronic processors, voltage converters, transistors and other components.

The voltage applied to the planar electrodes is preferably an AC voltage. In a preferred embodiment, the voltage source is a DC voltage source which provides a DC voltage and supplies the control unit therewith. This situation occurs, for example, in a vehicle if the laminated glass pane is a vehicle pane and is connected to the on-board voltage. The control unit is preferably connected to the on-board electrical system, from which it obtains the electrical voltage and optionally the information about the switching state. The control unit is then equipped with at least one inverter in order to convert the DC voltage into AC voltage. In a first embodiment, the control unit has a single inverter. To separately control the electrode segments of the first planar electrode, an output pole of the inverter has several independent outputs, wherein each electrode segment is connected to one of the outputs. One output of the inverter is thus associated with each switching region and connected to the corresponding electrode segment of the first planar electrode. The individual outputs are typically realized by switches, wherein the inverter generates a voltage which is subsequently switched. These switches can be integrated directly in the inverter. Alternatively, however, it is also possible for the inverter itself to have, strictly speaking, only a single output to which external switches are then connected in order to distribute the voltage to the switching regions. In the sense of the invention, such externally connected switches are also regarded as outputs of the inverter. The second planar electrode is also connected to the inverter. In a second embodiment, the control unit has several inverters, wherein each electrode segment is connected to its own inverter for separately controlling the electrode segments of the first planar electrode. One output of the inverter is thus associated with each switching region and connected to the corresponding electrode segment of the first planar electrode. The first embodiment has the advantage that it is more cost-effective and more space-saving. However, its disadvantage is that the switching regions can only be switched digitally between a switching state of 0% and a finite switching state, which corresponds to the output voltage of the inverter currently applied. The switching regions cannot be provided with different finite switching states (be independently “dimmable” as it were), which is possible without problems in the second embodiment.

The inverter(s) can be operated in such a way that a real AC voltage is generated, including the negative components thereof. This is possible both in the event where there is only a single inverter with independent outputs and in the event where each switching region is assigned its own inverter. Since, in the case of a DC voltage source, such as in the case of a vehicle, no negative potentials are however available, this solution is technically complex. Alternatively, it is possible and frequently preferred to simulate the AC voltage as it were. The control unit is equipped with several inverters, wherein each electrode segment of the first planar electrode is connected to a separate inverter and the second planar electrode to another inverter. Each electrode segment of the first planar electrode and of the second planar electrode is thus assigned its own inverter. The potentials of the inverters are modulated with a variable function, e.g., a sine function, wherein the potentials of the inverters of the electrode segments of the first planar electrode are in phase and the potential of the inverter of the second planar electrode is phase-shifted, in particular with a phase shift of 180°. The signal for the second planar electrode is then inverted compared to that of the first planar electrode. A temporally variable, periodic potential difference is thus generated with alternating relatively positive and relatively negative contributions, which corresponds to an AC voltage.

Since the on-board voltage of vehicles (for example 12 to 14 V) typically is not adequate for completely switching the functional element, the control unit will in addition preferably be equipped with a DC-DC converter which is suitable for increasing the supplied feed voltage (primary voltage), i.e., converting it into a higher secondary voltage (for example 65 V). The use of a DC-DC converter is not limited to the situation in vehicles, but may also be necessary or advantageous in other cases. The control unit is connected to the DC voltage source and is supplied with a primary voltage by the latter. The DC-DC converter converts the primary voltage into the higher secondary voltage. The inverter converts the secondary voltage into an AC voltage (for example 48 V), for which it is suitable. The AC voltage is then applied, on the one hand, to the electrode segments of the first planar electrode and, on the other hand, to the second planar electrode.

In an advantageous embodiment, the secondary voltage is 5 V to 70 V, the AC voltage is 5 V to 50 V.

In an advantageous development of the glazing unit according to the invention, the temperature of the laminated pane is determined.

In an advantageous development of the method according to the invention, the temperature T of the PDLC functional element is determined and steps A-D of the method according to the invention are carried out only if the temperature T is greater than 50° C., preferably greater than 60° C.

In an alternative or combined development of the method according to the invention, the temperature T of the PDLC functional element is determined and the steps A-D are carried out only if, after final application of the “on” switching state to the PDLC functional element, a temperature profile was passed through in which the temperature T at some point in time was greater than 40° C., preferably greater than 50° C. and particularly preferably greater than 60° C.

Alternatively or in combination, the voltage to be applied or the respective time duration t of the “on” switching state can be adapted to the determined temperature.

It is assumed here that the laminated glass pane has a homogeneous temperature overall, i.e., the temperature of the functional element matches the temperature of other regions of the laminated glass pane, which is typically at least approximately the case. Determining the temperature of the laminated glass pane accordingly corresponds at least approximately to determining the temperature of the functional element.

In an advantageous embodiment, the laminated glass pane is equipped with a temperature sensor. The temperature sensor is connected to the control unit in such a way that the control unit can ascertain the temperature of the laminated glass pane by means of the temperature sensor. The measurement signal of the temperature sensor is thus transmitted to the control unit and evaluated there so that the control unit determines the temperature of the laminated glass pane by means of the temperature sensor. The temperature sensor can be integrated into the laminated pane by embedding it in the intermediate layer. Alternatively, the temperature sensor can be fastened externally to the laminated glass pane or assigned thereto. Preferably, the temperature sensor is attached to the interior-side surface of the inner pane. The temperature sensor can also be arranged in the control unit itself or in a fastening element with which the control unit is fastened to the laminated glass pane. In principle, it is also possible to use a temperature sensor which is neither fastened directly to the laminated glass pane nor integrated therein but measures the temperature at a distance, e.g., an IR sensor which is arranged in the vicinity of the laminated glass pane and is directed to the latter.

In another advantageous embodiment, the control unit is suitable for determining the electrical impedance of the active layer and for determining the temperature of the laminated pane, or more precisely of the functional element, therefrom. This is possible since the impedance (the equivalent of the traditional ohmic resistance in the case of AC voltages) is temperature-dependent. In particular, an injective relationship exists between the real part of the electrical impedance and the temperature of the functional element. In this way, a temperature can be assigned to each impedance. In particular, the real part of the impedance as a function of the temperature is strictly monotonically decreasing. The embodiment has the advantage that it is possible to dispense with a temperature sensor which has to be integrated as a further component and therefore complicates the structure and increases the production costs.

Typically, the memory effect and the temperature dependence of the switching behavior are strongly pronounced above a certain limit temperature, while the temperature-dependent change below the limit temperature is less pronounced. The limit temperature for common functional elements is typically around 60° C. Higher temperatures occur in particular in strong sunlight. In one development of the invention it is therefore possible for the method to be carried out such that the temperature is determined and that the method according to the invention is carried out only after a temperature greater than a previously defined limit temperature has been reached (for example 50° C. or 60° C.).

The functional element according to the invention is a PDLC (polymer-dispersed liquid crystal) functional element. The active layer of a PDLC functional element contains liquid crystals which are embedded in a polymer matrix.

The functional element according to the invention is preferably a standard PDLC functional element which has maximum transmission and minimum opacity (clear, transparent state) in the “on” switching state with applied voltage and minimum transmission with maximum opacity (opaque, non-transparent (diffuse) state) in the “off” switching state with the voltage switched off. This means that if no voltage is applied to the planar electrodes, the liquid crystals will be aligned in an unordered manner, which results in strong scattering of the light passing through the active layer. If a voltage is applied to the planar electrodes, the liquid crystals will align in a common direction and the transmittance of light through the active layer is increased. However, other functional elements can also be used, the variability of whose optical properties is based on liquid crystals, for example PNLC (polymer-networked liquid crystal) functional elements.

Alternatively, the functional element according to the invention is preferably a reverse PDLC functional element (referred to also as a reverse mode PDLC), which has maximum transmission and minimum opacity (clear, transparent state) in the “off” switching state with the voltage switched off and minimum transmission with maximum opacity (opaque, non-transparent (diffuse) state) in the “on” switching state with applied voltage. The teaching according to the invention applies here accordingly.

The aforementioned controllable PDLC functional elements and their mode of operation are known per se to the person skilled in the art, so that a detailed description can be dispensed with at this point.

In an advantageous embodiment, the PDLC functional element comprises two carrier films in addition to the active layer and the planar electrodes, wherein the active layer and the planar electrodes are preferably arranged between the carrier films. The carrier films are preferably made of thermoplastic material, for example based on polyethylene terephthalate (PET), polypropylene, polyvinyl chloride, fluorinated ethylene propylene, polyvinyl fluoride or ethylene tetrafluoroethylene, particularly preferably based on PET. The thickness of the carrier films is preferably from 10 μm to 200 μm. Such functional elements can advantageously be provided, in particular purchased commercially, as multilayer films cut to size and shape and then laminated into the laminated pane, preferably via a respective thermoplastic connection layer with the outer pane and the inner pane. It is possible to segment the first planar electrode by laser radiation even when it is incorporated in such a multilayer film. A thin, visually inconspicuous insulation line can be produced by the laser treatment without damaging the carrier film typically lying above it.

The side edge of the functional element can be sealed, for example by merging the carrier layers or by a (preferably polymeric) tape. The active layer can thus be protected, in particular from constituents of the intermediate layer (in particular plasticizers) diffusing into the active layer, which can lead to degradation of the functional element.

For electrical contacting, the planar electrodes or electrode segments are preferably connected to so-called flat or foil conductors, which extend out of the intermediate layer beyond the side edge of the laminated pane. Flat conductors have a band-like metallic layer as their conductive core, which layer—except for the contact surfaces—is typically surrounded by a polymeric insulation sheath. Optionally, so-called bus bars, for example strips of an electrically conductive foil (for example copper foil) or electrically conductive printings, can be arranged on the planar electrodes, wherein the flat or foil conductors are connected to the said bus bars. The flat or foil conductors are connected to the control unit either directly or via further conductors.

In an advantageous embodiment, the control unit is fastened to the interior-side surface of the inner pane facing away from the intermediate layer. The control unit can, for example, be affixed directly to the surface of the inner pane. In an advantageous embodiment, the control unit is inserted into a fastening element, which in turn is fastened to the interior-side surface of the inner pane, preferably by means of a layer of an adhesive. Such fastening elements are also known as brackets in the vehicle sector and are typically made of plastic. Electrical connection of the laminated pane is facilitated by attaching the control unit directly to the laminated pane. In particular, no long cables are required between the control unit and the functional element.

Alternatively, however, it is also possible for the control unit not to be attached to the laminated pane, but rather, for example, to be integrated in the electrical system of the vehicle or fastened to the vehicle body if the laminated pane is a vehicle window pane. The control unit is preferably arranged in the interior of the vehicle such that it is not visible, for example in the dashboard or behind a paneling.

The laminated pane can be equipped with an opaque cover printing, in particular in a circumferential edge region, as is common practice in the vehicle sector, in particular for windshields, rear windows and roof panels. The cover printing is typically made of an enamel containing glass frits and a pigment, in particular black pigment. The printing ink is typically applied in a screen printing method and is then burned in. Such a cover printing is applied to at least one of the pane surfaces, preferably the interior-side surface of the outer pane and/or inner pane. The cover printing preferably surrounds a central see-through region in a frame-like manner and serves in particular to protect the adhesive, by which the laminated pane is connected to the vehicle body, against UV radiation. If the control unit is attached to the interior-side surface of the inner pane, it will preferably be attached in the opaque region of the cover printing.

The thermoplastic intermediate layer serves to connect the two panes, as is common practice with laminated panes. Thermoplastic films are typically used, and the intermediate layer is formed therefrom. In a preferred embodiment, the intermediate layer is formed at least from a first thermoplastic layer and a second thermoplastic layer, between which the functional element is arranged. The functional element is then connected to the outer pane via a region of the first thermoplastic layer and to the inner pane via a region of the second thermoplastic layer. The thermoplastic layers preferably project circumferentially beyond the functional element. Where the thermoplastic layers have direct contact with one another and are not separated from one another by the functional element, they can merge together during lamination in such a way that the original layers may no longer be discernible and instead a homogeneous intermediate layer is present.

A thermoplastic layer can be formed, for example, by a single thermoplastic film. A thermoplastic layer can also be formed from sections of different thermoplastic films, the side edges of which are attached to each other.

In a preferred embodiment, the functional element, more precisely the lateral edges of the functional element, is surrounded circumferentially by a third thermoplastic layer. The third thermoplastic layer is frame-like with a recess into which the functional element is inserted. The third thermoplastic layer can be formed by a thermoplastic film into which the recess has been introduced by cutting. Alternatively, the third thermoplastic layer can also be composed of a plurality of film sections around the functional element. The intermediate layer is then formed from a total of at least three thermoplastic layers arranged flat on top of each other, wherein the middle layer has a recess in which the functional element is arranged. During production, the third thermoplastic layer is arranged between the first and the second thermoplastic layer, wherein the lateral edges of all the thermoplastic layers are preferably congruent. The third thermoplastic layer preferably has about the same thickness as the functional element. This compensates for the local thickness difference which is introduced by the locally limited functional element, so that glass breakage during lamination can be avoided and an improved visual appearance result.

The layers of the intermediate layer are preferably formed from the same material, but can in principle also be formed from different materials. The layers or films of the intermediate layer are preferably based on polyvinyl butyral (PVB), ethylene vinyl acetate (EVA), or polyurethane (PU). This means that the layer or film predominantly contains the said material (more than 50% by weight) and can, in addition, optionally contain further constituents, for example plasticizers, stabilizers, UV or IR absorbers. The thickness of each thermoplastic layer is preferably from 0.2 mm to 2 mm, particularly preferably from 0.3 mm to 1 mm. For example, films with standard thicknesses of 0.38 mm or 0.76 mm can be used.

The outer pane and the inner pane are preferably made of glass, particularly preferably of soda lime glass, as is customary for window panes. However, the panes can also be manufactured from other types of glass, for example quartz glass, borosilicate glass or aluminosilicate glass, or from rigid clear plastics, for example polycarbonate or polymethyl methacrylate. The panes can be clear or also tinted or colored. Depending on the application, limits can be set to the degree of tinting or coloration: for example, a prescribed light transmission must sometimes be ensured, for example a light transmission of at least 70% in the main vision area A according to Regulation no. 43 of the Economic Commission for Europe of the United Nations (UN/ECE) (ECE-R43, “Uniform provisions concerning the approval of safety glazing materials and their installation on vehicles”).

The outer pane, the inner pane and/or the intermediate layer can have suitable coatings known per se, for example anti-reflective coatings, non-stick coatings, anti-scratch coatings, photocatalytic coatings, UV-absorbing or reflective coatings or IR-absorbing or reflecting coatings, such as sun protection coatings or low-E coatings.

The thickness of the outer pane and of the inner pane can vary widely and accordingly be adapted to the requirements in the individual case. The outer pane and the inner pane preferably have thicknesses of 0.5 mm to 5 mm, particularly preferably of 1 mm to 3 mm.

The invention also relates to the use of a glazing unit according to the invention, in particular of the laminated pane of a glazing unit according to the invention, in buildings or in means of transportation on land, in the air or in water, preferably as a window pane of a vehicle, in particular of a motor vehicle. The glazing unit can be used, for example, as a windshield, roof panel, rear wall pane or side pane.

In a particularly preferred embodiment, the glazing unit or the laminated pane is a windshield of a vehicle. The functional element is preferably used then as an electrically controllable sun screen, which is arranged in an upper region of the windshield, while the majority of the windshield is not provided with the functional element. The switching regions are preferably arranged substantially parallel to the upper edge of the windshield with increasing distance therefrom. As a result of the independently switchable switching regions, the user can determine the extent of the region bordering the upper edge which is to be shaded or provided with high light scattering, depending on the position of the sun, in order to avoid sun dazzle.

In yet another preferred embodiment, the glazing unit or the laminated pane is a roof panel of a vehicle. The functional element is then preferably arranged in the entire see-through area of the laminated pane. In a typical embodiment, this see-through area comprises the entire laminated pane minus a circumferential edge region which is provided with an opaque cover print on at least one of the surfaces of the panes. The functional element extends over the entire see-through area, wherein its side edges are arranged in the region of the opaque cover printing and are thus not visible to the observer. The switching regions are preferably arranged substantially parallel to the front edge of the roof panel with increasing distance therefrom. The user can define by means of the independently switchable switching regions which region of the roof panel is to be transparent and which should be shaded or provided with high light scattering, for example as a function of the position of the sun in order to avoid excessive heating of the vehicle interior. It is also possible for each vehicle passenger, i.e., for example, the driver, the front-seat passenger, the passenger in the left-hand back seat and the passenger in the right-hand back seat, to be assigned a switching region located above them.

The invention is explained in more detail with reference to a drawing and exemplary embodiments. The drawing is a schematic representation and is not true to scale. The drawing does not limit the invention in any way. In the drawings:

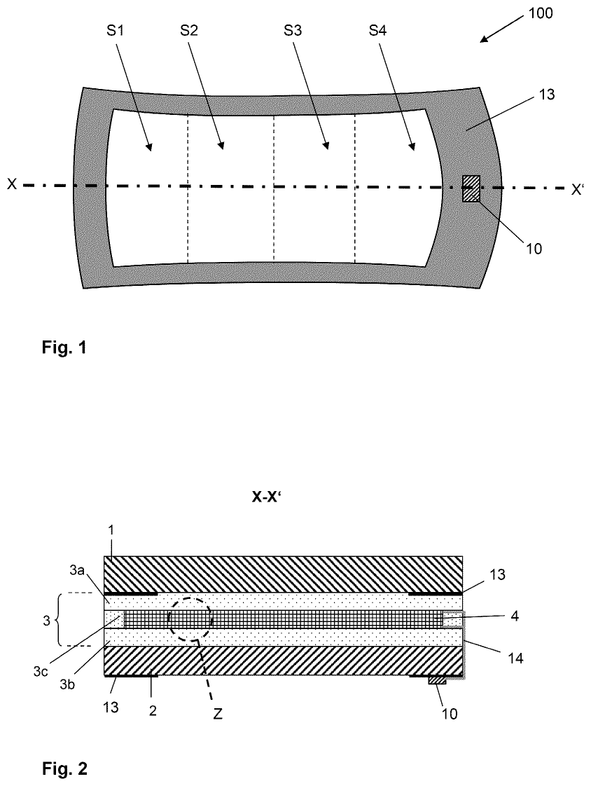

FIG. 1 shows a plan view of an embodiment of the glazing unit according to the invention;

FIG. 2 shows a cross-section through the glazing unit of FIG. 1;

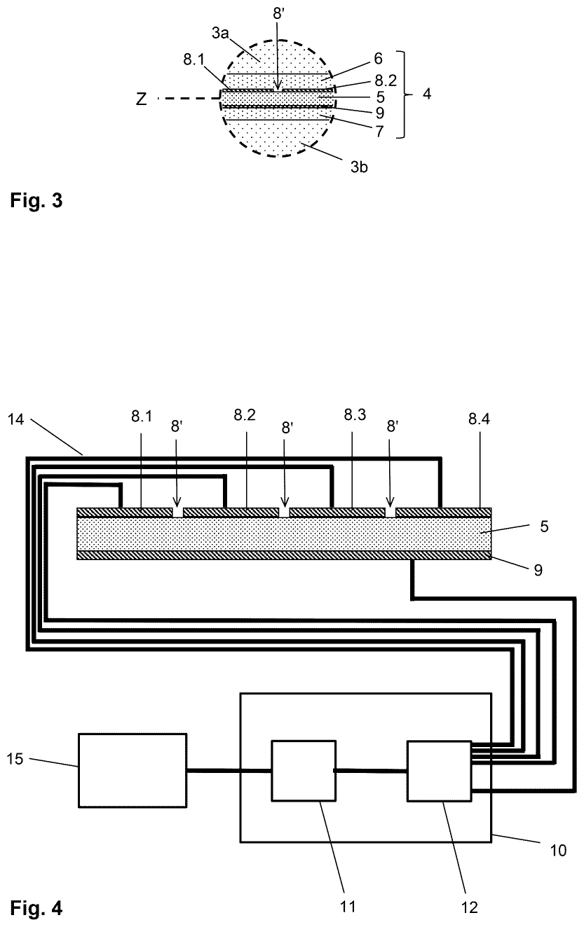

FIG. 3 shows an enlarged representation of the Z region of FIG. 2;

FIG. 4 shows the PDLC functional element of the glazing unit of FIG. 1 in an equivalent circuit diagram;

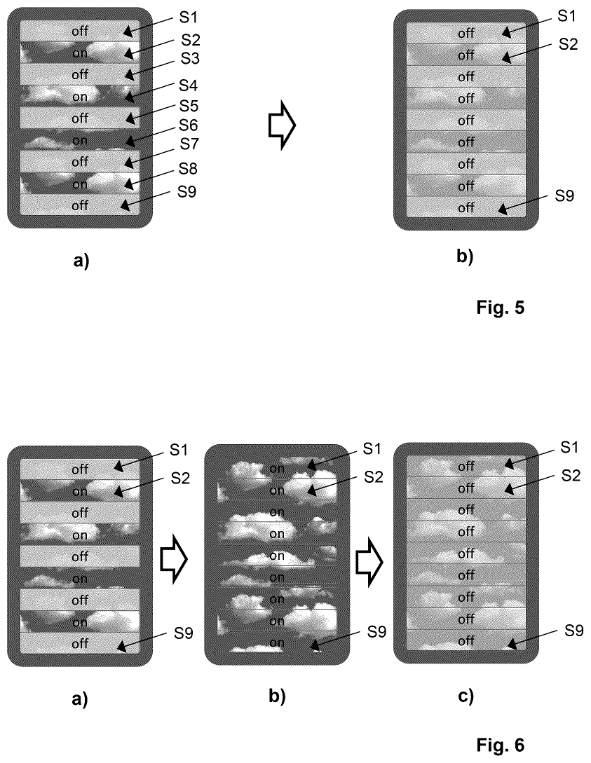

FIGS. 5a),b) show a schematic representation of the switching behavior of the PDLC functional element in a method according to the prior art;

FIGS. 6a)-c) show a schematic representation of the switching behavior of the PDLC functional element in the method according to the invention;

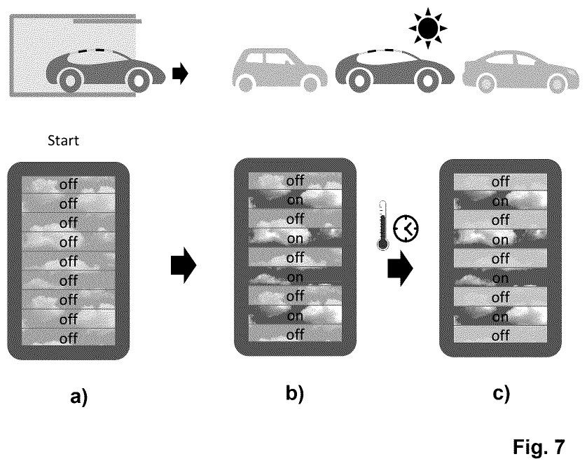

FIGS. 7a)-c) show a schematic representation of a typical application example; and

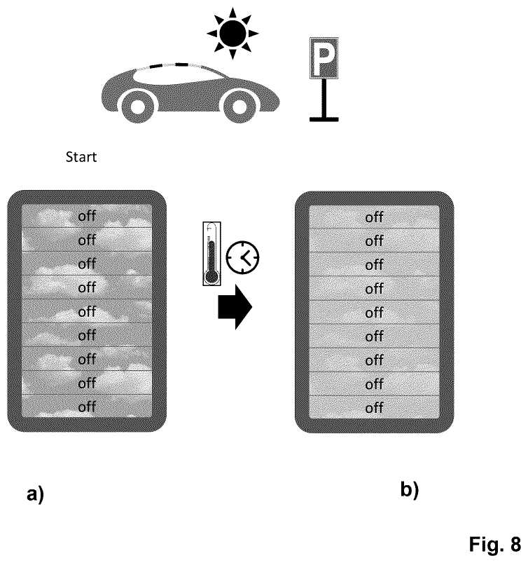

FIGS. 8a),b) show a schematic representation of another typical application example.

FIG. 1, FIG. 2, FIG. 3 and FIG. 4 each show a detail of a glazing unit 100 according to the invention having a PDLC functional element 4, which has electrically controllable optical properties. The glazing unit 100 comprises a laminated pane, which is provided, for example, as a roof pane of a passenger car, the optical properties of which, such as light transmission or light scattering, can be electrically controlled in certain areas. The laminated pane comprises an outer pane 1 and an inner pane 2, which are connected to one another via an intermediate layer 3. The outer pane 1 and the inner pane 2 consist, for example, of soda lime glass, which can optionally be tinted. The outer pane 1 has, for example, a thickness of 2.1 mm, the inner pane 2 has a thickness of 1.6 mm.

The intermediate layer 3 comprises, for example, a total of three thermoplastic layers 3a, 3b, 3c which are each formed by a PVB thermoplastic film having a thickness of 0.38 mm. The first thermoplastic layer 3a is connected to the outer pane 1, the second thermoplastic layer 3b is connected to the inner pane 2. The third thermoplastic layer 3c located in between has a cutout into which a PDLC functional element 4 is inserted substantially with a precise fit, i.e., approximately flush on all sides. The third thermoplastic layer 3c thus forms as it were a kind of mount or frame for the approximately 0.4 mm thick functional element 4, which is thus encapsulated by the thermoplastic material and protected thereby. The PDLC functional element 4 is, for example, a PDLC multilayer film which can be switched from a clear, transparent state to an opaque, non-transparent (diffuse) state.

Herein, the PDLC multilayer film is, for example, a standard PDLC multilayer film which has maximum transmission and minimum opacity (clear, transparent state) in the “on” switching state with applied voltage and minimum transmission with maximum opacity (opaque, non-transparent (diffuse) state) in the “off” switching state with the voltage switched off.

The PDLC functional element 4 is a multilayer film consisting of an active layer 5 between two planar electrodes 8, 9 and two carrier films 6, 7. The active layer 5 contains a polymer matrix with liquid crystals dispersed therein, which align depending on the electrical voltage applied to the planar electrodes 8, 9, whereby the optical properties can be adjusted. The carrier films 6, 7 are made of PET and have a thickness of, for example, 0.125 mm. The carrier films 6, 7 are provided with a coating of ITO facing the active layer 5 and having a thickness of approx. 100 nm, said coating forming the planar electrodes 8, 9. The planar electrodes 8, 9 are connected via bus bars (not shown) (formed, for example, from strips of a copper foil) to electrical cables 14, which produce the electrical connection to the control unit 10.

This control unit 10 is attached, for example, to the interior-side surface of the inner pane 2 facing away from the intermediate layer 3. For this purpose, for example, a fastening element (not shown) is glued to the inner pane 2, into which the control unit 10 is inserted. However, the control unit 10 does not necessarily have to be attached directly to the laminated pane. Alternatively, it can be attached, for example, to the dashboard or the vehicle body or can be integrated into the on-board electrical system of the vehicle.

The laminated pane has a circumferential edge region that is provided with an opaque cover printing 13. Such cover printing 13 is typically formed from a black enamel. It is imprinted as printing ink with a black pigment and glass frits in a screen printing method and is burned into the pane surface. The cover print 13 is applied, for example, on the interior-side surface of the outer pane 1 and also on the interior-side surface of the inner pane 2. The side edges of the functional element 4 are covered by this cover printing 13. The control unit 10 is arranged in this opaque edge region, i.e., glued onto the cover printing 13 of the inner pane 2. The control unit 10 does not interfere there with the view through the laminated pane and is visually inconspicuous. In addition, it is at a short distance from the side edge of the laminated pane, so that only advantageously short cables 14 are necessary for electrically connecting the functional element 14.

On the other hand, the control unit 10 is connected to the on-board electrical system of the vehicle, which, for the sake of simplicity, is not shown in FIGS. 1 and 2. The control unit 10 is suitable for applying the voltage to the planar electrodes 8, 9 of the PDLC functional element 4, which is required for the desired optical state of the PDLC functional element 4 (“on”/“off” switching state), depending on a switching signal which the driver specifies for example by pushing a button.

The laminated pane has, for example, four independent switching regions S1, S2, S3, S4 in which the switching state of the PDLC functional element 4 can be set independently of one another by the control unit 10. The switching regions S1, S2, S3, S4 are arranged one behind the other in the direction from the front edge to the rear edge of the roof panel, wherein the terms “front edge” and “rear edge” relate to the direction of travel of the vehicle. With the switching regions S1, S2, S3, S4, the driver of the vehicle can choose (for example as a function of the position of the sun) to provide only one region of the laminated pane instead of the entire laminated pane with the diffuse state, while the other regions remain transparent.

In order to form the switching regions S1, S2, S3, S4, the first planar electrode 8 is interrupted by three insulation lines 8′, which are arranged substantially parallel to one another and extend from a side edge to the opposite side edge of the functional element 4. The isolation lines 8′ are typically introduced into the first planar electrode 8 by laser machining and subdivide the latter into four electrode segments 8.1, 8.2, 8.3 and 8.4 which are materially separated from one another. Each electrode segment 8.1, 8.2, 8.3 and 8.4 is connected to the control unit 10 independently of the others. The control unit is suitable for applying, independently of one another, a voltage between each electrode segment 8.1, 8.2, 8.3 and 8.4 of the first planar electrode 8, on the one hand, and the second planar electrode 9, on the other hand, so that the section of the active layer 5 located in between is subjected to the required voltage in order to achieve a desired switching state.

As illustrated in the equivalent circuit diagram of FIG. 4, the control unit 10 is connected to a voltage source 15 via the on-board electrical system of the vehicle. In the vehicle sector, the voltage source 15 typically provides a DC voltage in the range of 12 V to 14 V (on-board voltage of the vehicle). The control unit 10 is equipped, for example, with a DC-DC converter 11, which converts the on-board voltage (primary voltage) into a DC voltage of higher magnitude, for example 65 V (secondary voltage). The secondary voltage must be sufficiently high in order to realize a switching state of the PDLC functional element 4 of 100%. The control unit 10 is furthermore equipped with an inverter 12 which converts the secondary voltage into an AC voltage. A pole of the inverter 12 is connected to the second planar electrode 9. For the other pole, the inverter 12 has several independent outputs, wherein each is in each case connected to an electrode segment 8.1, 8.2, 8.3 and 8.4 with one of the independent outputs so that the switching state of the associated switching region S1, S2, S3, S4 can be set independently of the others.

In the case of a switching state of 0% (“off”), the electrode segments 8.1, 8.2, 8.3, 8.4 and the second planar electrode 9 always have the same electrical potential so that no voltage is applied. In the case of a switching state greater than 0% (“on”) of a switching region S1, S2, S3, S4, a voltage is applied between the associated electrode segment 8.1, 8.2, 8.3, 8.4 and the second planar electrode 9. As a result of the voltage, a current flows through the associated section of the active layer 5.

FIGS. 5 a) and b) show a schematic representation of the switching behavior of the PDLC functional element 4 in a method according to the prior art. In this comparative example according to the prior art, the glazing unit 100 has nine adjacent and independently switchable switching regions (S1-S9) which are connected to a control unit 10 not shown herein (for example following the principle according to FIGS. 1-4).

FIG. 5 a) shows an alternating switching state, i.e., adjacent switching regions (electrode segments) have different switching states. For example, the switching regions S1, S3, S5, S7 and S9 have an “off” switching state, which corresponds, for example, to a maximum diffusivity (opacity or scattering) in the view through the PDLC functional element 4 in the respective switching region S1, S3, S5, S7 and S9. The immediately adjacent switching regions S2, S4, S6 and S8, which are separated from each other only by one isolation line 8′ between the electrode segments 8.1-8.9 (not shown in detail herein), have an “on” switching state, which corresponds, for example, to a minimum diffuse transparency (i.e., maximum clarity).

FIG. 5 b): If all switching regions S1-S9 are now switched directly to the “off” switching state by changing the “on” switching state of the switching regions S2, S4, S6 and S8, it is noticeable that the switching regions S2, S4, S6 and S8, which have changed their switching state from “on” to “off”, achieve a lower diffusivity than the switching regions S1, S3, S5, S7 and S9, which were already in the “off” switching state for a certain period of time and can therefore have a different switching history and a different temperature history. This effect can be referred to as the memory effect described above and increases in its severity with increasing temperature of the PDLC functional element 4. The resulting difference is not very aesthetic and can, for example, in vehicle glazing lead to glare for the driver or other passengers.

In other words, the inventive teaching can be described as follows: If the switching regions of the PDLC functional element 4, for example in the “off” switching state, are heated from room temperature to a temperature of, for example, 60° C. and then cooled again, then the transparency of the “new” “off” switching state differs from the “old” “off” switching state before the temperature profile was passed through. If the switching regions of the PDLC functional element 4 are then switched on (“on”) and off again (“off”), the first “off” switching state, which corresponds to a “fresh” memory state, is restored. One therefore always wants to ensure the “fresh” memory state (“off” switching state) as soon as adjacent switching regions are switched on and off again, since they are inevitably in said “fresh” memory state after having been switched off.

FIGS. 6 a) and b) show a schematic representation of the switching behavior of the PDLC functional element 4 when applying the method according to the invention. The glazing unit 100 of this example according to the invention corresponds in its basic structure to that of the comparative example according to the prior art of FIG. 5, so that reference is made to the description under FIG. 5.

FIG. 6 a), analogously to FIG. 5 a), shows an alternating switching state, i.e., adjacent switching regions have different switching states. For example, the switching regions S1, S3, S5, S7 and S9 have an “off” switching state, which corresponds, for example, to a maximum diffusivity (opacity or scattering) in the view through the PDLC functional element 4 in the respective switching region S1, S3, S5, S7 and S9. The immediately adjacent switching regions S2, S4, S6 and S8, which are separated from each other only by one isolation line 8′ between the electrode segments 8.1-8.9 (not shown in detail herein), have an “on” switching state, which corresponds, for example, to a minimum diffuse transparency (i.e., maximum clarity).

In contrast to the comparative example according to the prior art in FIGS. 5 a) and b), when the switching states of individual switching regions are changed, all switching states of the switching regions S1-S9 are initially set to the “on” switching state for, for example, a time period t of 0.5 s (see FIG. 6 b)). Subsequently, for example, all switching regions S1-S9 are set to the “off” switching state by applying a suitable control voltage via the control unit 10.

As can be seen in FIG. 6 c), all switching regions S1-S9 have the same optical properties and in particular the same diffusivity, regardless of whether they were originally in the “on” switching state (like switching regions S2, S4, S6, S8) or already in the “off” switching state (like switching regions S1, S3, S5, S7, S9).

This creates an even view, with little glare for the driver or other passengers. The memory effect described in FIGS. 5 a) and b) can be effectively avoided regardless of the temperature T of the PDLC functional element 4.

As already mentioned, said memory effect always occurs to a certain extent and especially at temperatures above, for example, 50° C.

Without limiting the invention, the effect is particularly evident in the following initial constellations:

Depending on changing temperatures of the glazing unit 100 in different application scenarios, the optical properties in the switched off state may change during operation or between two uses (morning/evening, next day). FIGS. 7 a)-c) show a scenario during operation of the vehicle. FIGS. 8 a)-b) between two uses.

FIGS. 7 a)-c) schematically show the initial constellation of a vehicle parked in a garage. In FIG. 7 a), the vehicle is parked in a (relatively cool) garage; the glazing unit 100 with PDLC functional element 4 is in the “off” switching state, i.e., it is de-energized and thus in a diffuse state.

FIG. 7 b) shows a glazing unit 100 with alternating “on”/“off” switching regions. The glazing unit 100 then heats up to over 60° C., for example under the influence of sunlight and with only a slight wind in city traffic, for example for a period of approximately 2 hours.

FIG. 7 c) shows the glazing unit under the influence of temperature, wherein the switching regions that have now been switched “off” for a long period of time have a more diffuse transparency than after a short switch-on time and cooler state of FIG. 7 b). FIG. 7 c) now corresponds, for example, to the initial state of FIG. 5 a) of the comparative example according to the prior art or FIG. 6 a) of the example according to the invention.

By applying the method according to the invention, homogeneous optical properties are obtained over the entire surface of the switching regions.

FIGS. 8 a) and b) schematically show another initial constellation using the example of a vehicle parked in the sun. In FIG. 8 a), the glazing unit 100 is comparatively cold and is in the “off” switching state, i.e., it is de-energized and thus in a diffuse state.

FIG. 8 b) shows the glazing unit 100 after a parking time of approximately 2 hours and heating by sunlight to, for example, over 60° C. FIG. 8 b) shows the glazing unit after it has experienced a change in temperature. The switching regions that have now been switched “off” for a long time show a more diffuse transparency than the state before the temperature influence in FIG. 8 a).

If an alternating switching pattern as in FIG. 5 a) or 6 a) is now applied to the glazing unit 100, and if it is immediately switched completely “off” again according to the prior art (without an intermediate “on” switching state), the pattern according to FIG. 5 b) results. The switching regions S1, S3, S5, S7, S9 that were not switched “on” retain a stronger diffusivity than the switching regions S2, S4, S6, S8, which were switched “on” and then “off” again, since the memory state is now restored in the latter switching regions.

An inventive “on” switching of all switching regions (as shown in FIG. 6 b)) restores the memory state of the PDLC functional element, so that when all switching regions are subsequently switched “off”, a homogeneous optical diffusivity is created over the entire surface of the switching regions (see FIG. 6c).

### LIST OF REFERENCE SIGNS

1 Outer pane
2 Inner pane
3 Thermoplastic intermediate layer
3a First layer of the intermediate layer 3
3b Second layer of the intermediate layer 3
3c Third layer of the intermediate layer 3
4 PDLC functional element, functional element with electrically controllable optical properties
5 Active layer of the functional element 4
6 First carrier film of the functional element 4
7 Second carrier film of the functional element 4
8 First planar electrode of the functional element 4
8.1, 8.2, 8.3, 8.4 Electrode segments of the first planar electrode 8
8′ Isolation line between two electrode segments 8.1, 8.2, 8.3, 8.4
9 Second planar electrode of the functional element 4
10 Control unit
11 DC-DC converter
12 Inverter
13 Cover print
14 Electrical cable
15 Voltage source/DC voltage source
100 Glazing unit
S1, S2, S3, S4, S5, S6, S7, S8, S9, Sn, Sn+1 Switching region
n Natural number
t Duration
T Temperature
X-X′ Section line
Z Enlarged region
on, off switching state

1. A method for controlling a PDLC functional element having at least two adjacent, independently switchable switching regions, wherein switching states are applicable to the switching regions by a control unit, the method comprising:
A) applying different switching states to at least two adjacent switching regions;
B) sending a signal to the control unit by a user or an automatic control to change the switching states in the individual switching regions;
C) first setting all switching regions set to the switching state; and
D) then applying the changed switching states to the switching regions.

2. The method according to claim 1, wherein in step C the on switching state is applied in all switching regions simultaneously.

3. The method according to claim 1, wherein, in step C, the on switching state is applied in the switching regions at different times.

4. The method according to claim 1, wherein in step C the on switching state is held in the switching regions for a time period t of greater than or equal to 1/60 s.

5. The method according to claim 1, wherein the method is carried out again if in step D different switching states are applied to at least two adjacent switching regions.

6. The method according to claim 1, wherein the temperature T of the PDLC functional element is determined and steps A-D are carried out only if the temperature T is greater than 40° C., and/or the temperature T of the PDLC functional element is determined and steps A-D are carried out only if, after final application of the on switching state to the PDLC functional element, a temperature profile was passed through in which the temperature T at some point in time was greater than 40° C.

7. A glazing unit with a PDLC functional element, comprising:
a laminated pane, comprising:
an outer pane and an inner pane, which are connected to one another via at least one thermoplastic intermediate layer,
a PDLC functional element with at least two adjacent, independently switchable switching regions, which is arranged between the outer pane and the inner pane, wherein
the PDLC functional element has at least two adjacent, independently switchable switching regions,
and
a control unit for electrically controlling the optical properties of the switching regions of the PDLC functional element,
wherein the control unit is provided to carry out a method according to claim 1.

8. The glazing unit according to claim 7, wherein the PDLC functional element has an active layer with electrically controllable optical properties between a first planar electrode and a second planar electrode and the first planar electrode is divided into at least two separate electrode segments by at least one isolation line and each electrode segment forms an independently switchable switching region.

9. The glazing unit according to claim 8, wherein each electrode segment of the first planar electrode and the second planar electrode are electrically connected to the control unit, so that an electrical voltage is applicable between each electrode segment of the first planar electrode and the second planar electrode, independently of one another, in order to control the optical properties of the section of the active layer located therebetween.

10. The glazing unit according to claim 8, wherein the second planar electrode has no isolation lines or a smaller number of isolation lines and consequently a smaller number of electrode segments than the first planar electrode, so that at least one electrode segment of the second planar electrode is assigned several electrode segments of the first planar electrode.

11. The glazing unit according to claim 7, wherein the laminated pane is equipped with a temperature sensor which is connected to the control unit in such a way that the control unit is adapted to determine the temperature T of the laminated pane by the temperature sensor, or the control unit is suitable for determining the impedance of the active layer and for determining the temperature T of the laminated pane therefrom.

12. The glazing unit according to claim 7, wherein the at least one isolation line has a width of 5 μm to 500 μm.

13. A vehicle comprising a laminated pane according to claim 7.

14. A method comprising providing a method according to claim 1 for controlling a PDLC functional element in a glazing unit.

15. The method according to claim 3, wherein, in step C, the on switching state is applied in the switching regions in a rolling function or alternating sequence.

16. The method according to claim 3, wherein step D is carried out only after each switching region has been set to the on switching state at least once.

17. The method according to claim 4, wherein the time period t is from 0.5 s to 10 s.

18. The method according to claim 6, wherein the temperature T of the PDLC functional element is determined and steps A-D are carried out only if the temperature T is greater than 50° C. and/or the temperature T of the PDLC functional element is determined and steps A-D are carried out only if, after final application of the on switching state to the PDLC functional element, a temperature profile was passed through in which the temperature T at some point in time was greater than 50° C.

19. The glazing unit according to claim 12, wherein the at least one isolation line has a width of 20 μm to 200 μm.

20. The vehicle according to claim 13, wherein the vehicle is a passenger vehicle.
